(19) United States
(12) Patent Application Publication
(10) Pub. No.: US 2009/0126730 A1
(43) Pub. Date: May 21, 2009

(54) Anesthesia Apparatus Preoperative Checkout Device

(76) Inventor: S. E. Smith, Dallas, TX (US)

Correspondence Address: WILSON DANIEL SWAYZE, JR., 3804 CLEARWATER CT., PLANO, TX, 75025, US

(21) Appl. No.: 12/118,872

(22) Filed: May 12, 2008

Related U.S. Application Data
(63) Continuation-in-part of application No. 11/940,888, filed on Nov. 15, 2007.

(51) Int. Cl. A62B 27/00

(52) U.S. Cl. 128/202.22

(57) ABSTRACT

A checkout device to test an anesthesia machine may include a connecting tube to connect the checkout device to the anesthesia machine to transmit fluid, and a valve positioned in the connecting tube having a first position at a second position. The first position may allow the fluid to flow without substantial resistance and the second position may prevent the fluid from flowing until a predetermined resistance level has been overcome. The valve may include an arm to open which corresponds to the first position and to close which corresponds to the second position, and the valve may include a movable piston to open and close the valve. The movable piston may be connected to a biasing apparatus to move the movable piston to open and close the valve, and the movable piston may be connected to the arm.

### PRIORITY

The present application is a continuation in part of the application filed on Nov. 15, 2007 with a Ser. No. 11/940,888.

### FIELD OF THE INVENTION

The present invention relates to anesthesia machines and more particularly to a method and apparatus for providing a checkout of the operational characteristics of the anesthesia machine.

### BACKGROUND

The standard guidelines for a complete check out of the anesthesia machine has been reviewed in the ‘Anesthesia Apparatus Checkout Recommendations, 1993’ from the FDA. These recommendations along with specific manufacturer guidelines form the basis for a safe and complete preoperative checkout of the anesthesia machine. Although, it is recommended that the anesthesia machine be checked out for each and every patient and for each and every use, the approved checkout routine may not always be completed. These checkout procedures require a large amount of time in order to complete. In some emergency situations, a few minutes can make the difference between life and death. Consequently, there is insufficient time to complete the checkout procedures. Under these circumstances, the anesthesia specialist may forgo the complete checkouts or perform an abbreviated set of checkouts in order to save the patient's life.

The FDA 1993 guidelines are thorough, rational and yet cumbersome. The order of checkout requires, for instance, turning off the machine or interrupting critical connections of the machine. In an emergency situation, few practitioners will follow these FDA guidelines since it is critical that the machine be made ready immediately.

### SUMMARY

A checkout device to test an anesthesia machine may include a connecting tube to connect the checkout device to the anesthesia machine to transmit fluid, and a valve positioned in the connecting tube having a first position at a second position.

The first position may allow the fluid to flow without substantial resistance and the second position may prevent the fluid from flowing until a predetermined resistance level has been overcome.

The valve may include an arm to open which corresponds to the first position and to close which corresponds to the second position, and the valve may include a movable piston to open and close the valve.

The movable piston may be connected to a biasing apparatus to move the movable piston to open and close the valve, and the movable piston may be connected to the arm.

The checkout device may be adapted to be connected to an anesthesia bag, and the checkout device may include a recessed area.

The recessed area includes a first end of the connecting tube, and the connecting tube may include a inlet for oxygen.

The connecting tube may include a inlet for carbon dioxide, and the valve may include a substantially U-shaped passageway.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the checkout device of the present invention;

FIG. 2 illustrates a side view of a valve which is adapted to be used with the checkout device of the present invention;

FIG. 3 illustrates a side view of the checkout device of the present invention;

FIG. 4 illustrates a cross-sectional side view of the checkout device of the present invention.

FIG. 5 illustrates another cross-sectional view of the valve of the present invention with the piston moved forward.

FIG. 6 illustrates another cross-sectional view of a valve of the present invention with the arm in an open position.

### DETAILED DESCRIPTION

The device of the present invention speeds the checkout of a anesthesia apparatus (for example anesthesia machine) in order to assure that the anesthesia apparatus is working properly especially in cases where an emergency dictates an abbreviated checkout. In contrast to the FDA guidelines, a more practical approach to preparing the anesthesia machine 464 is to check the machine 464 in the order of the important components to the patient. These checks may include first, taking into consideration the aspects of the machine 464 that are most likely to fail based upon the actual model of the machine 464, the hospital, the actual operating suite or the pattern of practice. This approach usually is individually developed by the practitioner during the checkout to meet the current emergency situation.

The present invention describes a device that tests for acceptable machine performance. An interchangeable reserve bag 466 of appropriate size is attached to a connector 110 which can in turn be opened to an appropriately sized facemasks or attached to the tubing of the anesthesia machine 464. Depending on the level of complexity of the task that is currently desired, the device 100 can be simply be ventilated by the practitioner or other parameters can be added to make the checkout of the machine 464 more thorough and realistic. To check the ability of a circuit of the anesthesia machine 464 to maintain a minimum pressure or a back pressure, a predetermined pressure resistance or pressure threshold can be set adjusting to the removable end member 254. In this connection, the predetermined pressure resistance or pressure threshold could be set to simulate the actual pressure required to ventilate the patient. An additional test could be used to sense the presence of oxygen from the anesthesia machine 464 with respect to the presence of oxygen in the room. Furthermore, another test would be for the anesthesia device 464 to emit carbon dioxide from an internal or external tank while the desired oxygen concentration is being sensed from the anesthesia machine 464. It would be desirable for the device of the present invention to be small and portable so that it could be used in a large number of locations. It would be desirable that the device of the present invention to be placed near the head of the prospective patient or attached near the head of the operating table.

This device 100 may be used for an expedited checkout in an emergency situation to determine the ability of the anesthesia apparatus 464 to deliver air which has been oxygen enriched and to sense carbon dioxide which has been emitted from the patient in order to supply the air which has been oxygen enriched at the necessary pressure to aid in ventilation. Furthermore, other machine characteristics and factors can be checked as time permits.

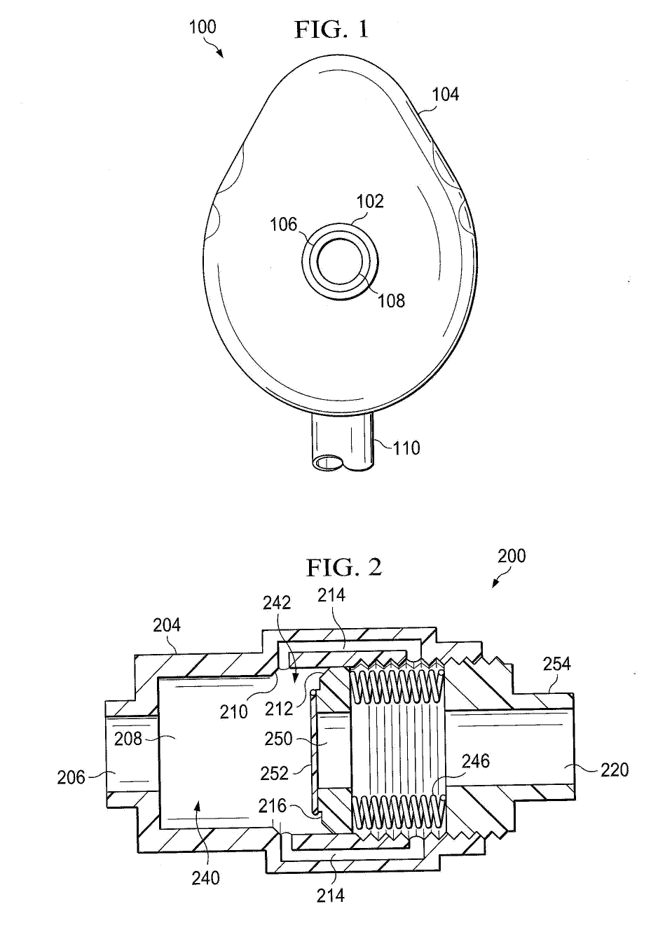

FIG. 1 illustrates the checkout or test device 100 of the present invention. The checkout device may have an outside perimeter 104 and may be oval or egg shaped and may be made from flexible material such as plastic or other suitable material. The checkout device 100 may include a recessed area at approximately the center of the checkout device 100 in order to connect to the anesthesia device 464 as illustrated in FIG. 4. FIG. 4 additionally illustrates that the checkout device 100 may be connected to an anesthesia bag 466 such as illustrated in FIG. 4. FIG. 1 illustrates the outer perimeter 102 of the recessed area to define the recessed area and illustrates the outside perimeter 106 of the first end 109 of a connecting tube 107 and the inside perimeter 108 of the first end 109 of the connecting tube 107. The recessed area provides a connection to the anesthesia machine 464.

FIG. 1 additionally illustrates the second end 110 of the connecting tube 107. The connecting tube 107 may be made from flexible material such as plastic or other suitable material. The second end 110 of the connecting tube is at substantial right angle to the first end 109 of the connecting tube 107.

FIG. 2 illustrates a valve 200 of the present invention. The valve 200 includes an outer housing 204 for enclosing the valve 200. The valve 200 includes a first end passageway 206 to allow air or other fluids to enter and exit the valve 200 and to allow connection to the connection tube 107. The valve 200 includes a second middle passageway 208 to connect the first end passageway 206 to the third end passageway 220 which allows air and other fluids to enter and exit the valve 200 and which connects to the connection tube 107. The second middle passageway 208 includes a first region 240 and a second region 242 which has a wider diameter than the first region 240 and which includes a bypass passageway 214 which is shown as being substantially an inverted U-shaped passageway to bypass the movable piston 216 when the movable piston 216 has been forced back by the pressure of the air.

FIG. 2 illustrates that the outer housing 204 includes an inclined shoulder 210 to cooperate within an inclined surface 212 on the movable piston 216. When the movable piston 216 is biased forward by the biasing apparatus 246 which may be a spring, the inclined shoulder 210 forms a seal with the inclined surface 212 to block the U-shaped passageway 214. The movable piston 216 includes a central passageway 250 which is opened and closed by a movable arm 252.

When the air or fluid flows from the third end passageway 220 to the first end passageway 206, the movable arm 252 opens the central passageway 250 to allow the air overflow in to flow substantially unimpeded or with little resistance to the first end passageway 206. This is the first position of the operation of the valve.

The biasing apparatus 246 is connected to a removable end member 254 which includes external threads to mate with internal threads positioned on the outer housing 204. The third end passageway 220 is centrally located within the removable end member 254. The amount of biasing that the biasing apparatus 246 imparts to the movable piston 216 depends on the distance that the removable end member 254 has been threaded into the outer housing 204. In this matter, the user is able to control the amount of air pressure that is input to the first end passageway 206 to move the movable piston 216 against the biasing apparatus 246.

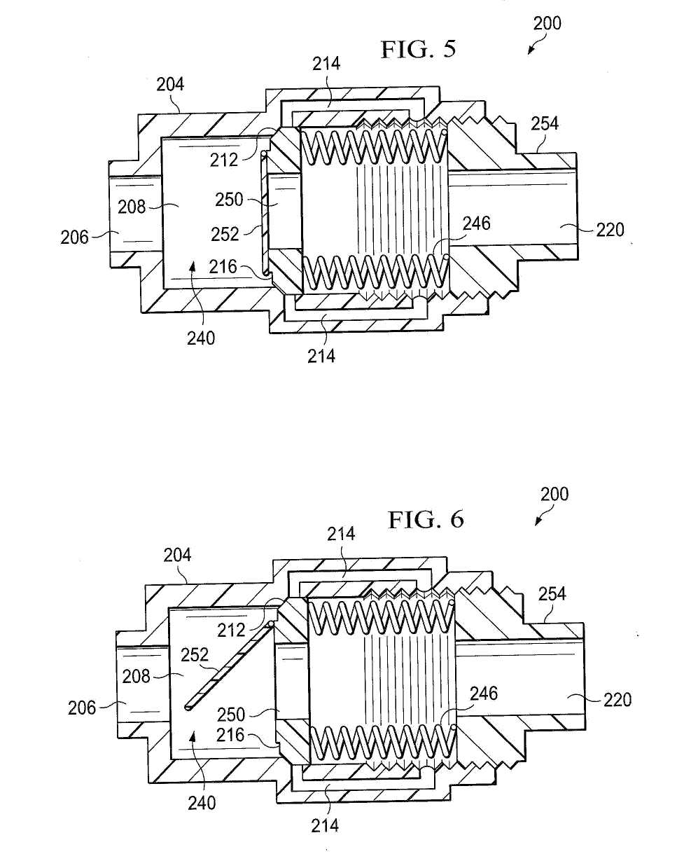

FIG. 5 illustrates the valve 200 of the present invention with the movable piston 216 that has been moved forward with respect to the second middle passageway 208 to seal the U-shaped passageway 214 and the third end passageway 220 as a result of the biasing apparatus 246. The movable piston 216 may be moved in the direction of the third end passageway 220 as a result of pressure from the first end passageway 206 of the fluid exceeding a predetermined level on the movable piston 216 to overcome the force of the biasing apparatus 246.

FIG. 6 illustrates the valve 200 of the present invention with the movable arm 252 which has been moved to an open position as a result of pressure from the third end passageway 220. The shoulder 212 is positioned against the inclined edge 210 closing the U-shaped passage 214. The movable piston 216 is closed with the movable arm 252 open.

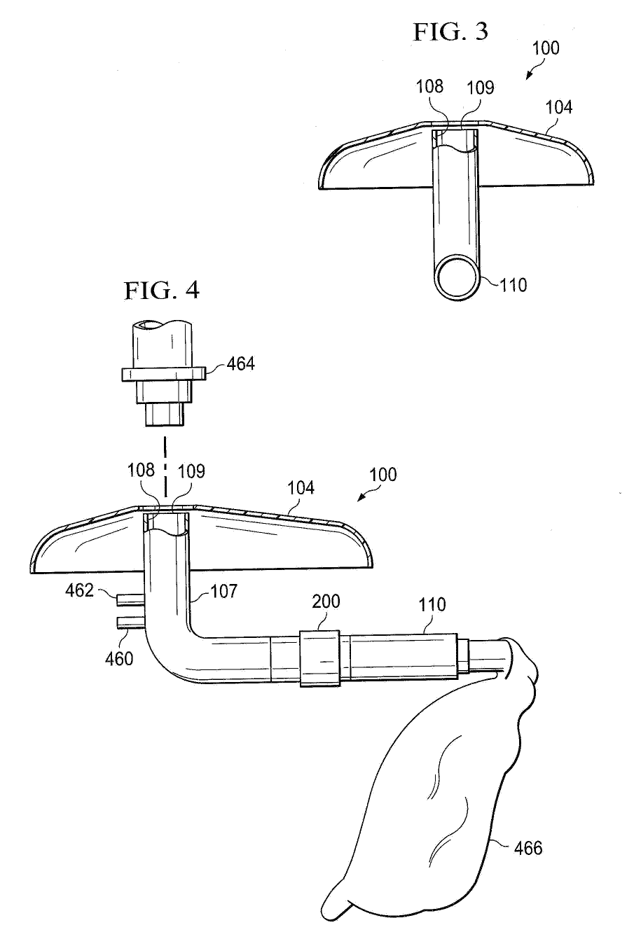

FIG. 3 illustrates a side view of the checkout device 100 of the present invention and illustrates the first end 109 of the connecting tube 107 and the second end 110 of the connecting tube 107. FIG. 3 illustrates that the first end 109 of the connector tube 107 does not extend to the outside perimeter 104 of the checkout device 100 and may not extend to the interior perimeter of the checkout device 100.

FIG. 4 illustrates a side view of the checkout device 100 of the present invention and illustrates the first end 109 of the connecting tube 107 and the second end 110 of the connecting tube 107. Additionally FIG. 4 illustrates a first inlet 460 which may be used for oxygen or air and a second inlet 462 which may be a source of carbon dioxide. FIG. 4 illustrates that the first end 109 of the connector tube 107 does not extend to the outside perimeter 104 of the checkout device 100 and may not extend to the interior perimeter of the checkout device 100. FIG. 4 additionally illustrates that the anesthesia machine 464 includes a male connector which cooperates with the first end 109 of the connector tube 107 to form a seal with the connector tube 107.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A checkout device to test an anesthesia machine, comprising:
a connecting tube to connect the checkout device to the anesthesia machine to transmit fluid;
a valve positioned in the connecting tube having a first position at a second position,
wherein the first position allows the fluid to flow without substantial resistance and the second position prevents the fluid from flowing until a predetermined resistance level has been overcome.

2) as in claim 1, wherein the valve includes an arm to open which corresponds to the first position and to close which corresponds to the second position.

3) as in claim 2, wherein the valve includes a movable piston to open and close the valve.

4) as in claim 3, wherein the movable piston is connected to a biasing apparatus to move the movable piston to open and close the valve.

5) as in claim 4, wherein the movable piston is connected to the arm.

6) as in claim 1, wherein the checkout device is adapted to be connected to an anesthesia bag.

7) as in claim 1, wherein the checkout device includes a recessed area.

8) as in claim 7, wherein the recessed area includes a first end of the connecting tube.

9) as in claim 1, wherein the connecting tube includes a inlet for oxygen.

10) as in claim 1, wherein the connecting tube includes a inlet for carbon dioxide.

11) as in claim 1, wherein the valve includes a substantially U-shaped passageway.
